(19) United States
(12) Patent Application Publication
(10) Pub. No.: US 2023/0103299 A1
(43) Pub. Date: Apr. 6, 2023

(54) RELEASE BEARING ARRANGEMENT FOR AN AXIALLY MOVABLE PISTON OF A CLUTCH CYLINDER OF A MULTI-PLATE CLUTCH, CLUTCH CYLINDER ARRANGEMENT AND DOUBLE PLATE CLUTCH

(71) Applicant: Schaeffler Technologies AG & Co. KG, Herzogenaurach (DE)

(72) Inventors: Mario Willian Privatti, Sorocaba (BR); Bruno Pavane, Sorocaba (BR)

(73) Assignee: Schaeffler Technologies AG & Co. KG, Herzogenaurach (DE)

(21) Appl. No.: 17/798,331

(22) PCT Filed: Jan. 12, 2021
(86) PCT No.: PCT/DE2021/100022

§ 371 Date: Aug. 9, 2022

(30) Foreign Application Priority Data
Feb. 12, 2020 (DE) 10 2020 103 595.0

(51) Int. Cl. F16D 23/14; F16D 25/08; F16C 19/16

(52) U.S. Cl. CPC F16D 23/14; F16C 19/16; F16D 25/083

(57) ABSTRACT

A release bearing arrangement is provided for a piston of a clutch cylinder of a multi-plate clutch, which piston is axially movable along a shaft of a motor vehicle. The release bearing arrangement includes a release bearing for axial force transmission of an actuating force introduced by the piston to a transmission device of the multi-plate clutch. The release bearing has a first bearing plate, a second bearing plate and a plurality of rolling elements, the rolling elements being arranged so as to roll between the first bearing plate and the second bearing plate. The release bearing arrangement has a self-centering device for radial self-centering of the release bearing relative to the shaft and/or relative to the piston that is axially movable along the shaft.

### CROSS REFERENCE TO RELATED APPLICATIONS

This application is the U.S. National Phase of PCT Appln. No. PCT/DE2021/100022 filed Jan. 12, 2021, which claims priority to DE 10 2020 103 595.0 filed Feb. 12, 2020, the entire disclosures of which are incorporated by reference herein.

### TECHNICAL FIELD

The disclosure relates to a release bearing arrangement for an axially movable piston of a clutch cylinder of a multi-plate clutch. The release bearing arrangement comprises a release bearing for axial force transmission of an actuating force introduced by the piston to a transmission device of the multi-plate clutch, wherein the release bearing comprises a first bearing plate, a second bearing plate and a plurality of rolling elements. The rolling elements are arranged as to roll between the first bearing plate and the second bearing plate. The disclosure further relates to a clutch cylinder arrangement for a double-plate clutch and to a double-plate clutch comprising the clutch cylinder arrangement.

### BACKGROUND

Ball bearings are usually used in clutches as release bearings, as disclosed, for example, in DE 10 2008 019 949 A1. The use of axial needle bearings as release bearings in multi-plate clutches is also already known from the prior art. For example, DE 10 2017 129 873 A1 describes a hybrid module with an actuation unit comprising needle bearings and a hybrid drive train. In double clutches, ball bearings are often used as release bearings, for example in accordance with the disclosure in DE 10 2008 019949 A1.

### SUMMARY

The disclosure is based on the object of providing a functionally improved release bearing arrangement for an axially movable piston of a clutch cylinder of a multi-plate clutch. In particular, release bearing arrangements with axial needle bearings as release bearings are to be provided that can be used in double-plate clutches in a functionally reliable and durable manner. This object is achieved by a release bearing arrangement for an axially movable piston of a clutch cylinder of a multi-plate clutch with the features of claim 1, by a clutch cylinder arrangement for a double-plate clutch with the features of claim 7 and by a double-plate clutch with the clutch cylinder arrangement with the features of claim 10. Preferred or advantageous embodiments of the disclosure will be apparent from the subclaims of the following description and/or the accompanying figures.

A release bearing arrangement is proposed for a piston, which is axially movable along a shaft of a motor vehicle, of a clutch cylinder of a multi-plate clutch, in particular a single, double or multiple clutch. In the case of a double or multiple clutch, the shaft preferably comprises a hollow shaft and a concentric solid shaft, which extends within the hollow shaft. Preferably, the piston is designed as an annular piston. In particular, the piston for actuating the multi-plate clutch is movable in an axial direction. For example, the multi-plate clutch is designed for a drive train of a motor vehicle. The multi-plate clutch can be a dry clutch, preferably it is a wet clutch.

In particular, the multi-plate clutch comprises a plate pack with a plurality of plates and a transmission device for transmitting an actuating force to the plate pack. The transmission device is designed, for example, as a pressure plate or disc spring. The transmission device can bring the plates of the plate pack into frictional contact, for example by means of a pressure pad.

The release bearing arrangement comprises a release bearing which is designed and/or arranged to transmit the actuating force introduced by the piston to the transmission device of the multi-plate clutch. Preferably, the release bearing is designed as an axial needle bearing.

The release bearing comprises a first bearing plate and a second bearing plate. In particular, each bearing plate has an inner diameter and an outer diameter. The release bearing further comprises a plurality of rolling elements arranged as to roll between the first bearing plate and the second bearing plate. The rolling elements are preferably rotatably mounted in a cage.

Advantageously, the first bearing plate is operatively connected to the transmission device of the multi-plate clutch. In particular, the first bearing plate transmits the actuating force to the transmission device so that the plates of the multi-plate clutch are pressed together in a frictionally engaged manner and the multi-plate clutch is actuated. Preferably, the second bearing plate is arranged on the piston side in the axial direction.

According to the disclosure, the release bearing arrangement has a self-centering device. The self-centering device is designed to radially center the release bearing relative to the shaft of the motor vehicle and/or to the axially movable piston. In a conventional release bearing formed by an axial needle bearing, some radial displacement relative to the shaft and/or piston is possible. The self-centering device can introduce a self-centering force into the axial needle bearing, which keeps or positions the axial needle bearing centered on the shaft and/or relative to the piston against acting displacement forces.

In an advantageous embodiment of the disclosure, the self-centering device comprises a securing housing. For example, the securing housing is designed to be annular in an axial plan view. Preferably, the securing housing is designed to receive the release bearing in regions and to secure the release bearing to the piston.

In one embodiment of the disclosure, the release bearing is received in the securing housing in regions. Preferably, the securing housing is attached to the piston, e.g. the securing housing can be inserted into or attached to the piston and/or connected to it in a form-fitting or force-fitting manner. Optionally, the securing housing has several form-fit interfaces for this purpose, which are arranged in the direction of rotation on a housing jacket of the securing housing.

One embodiment of the disclosure provides that the securing housing has an annular receiving portion on an axial end face. The annular receiving portion, in particular, has a receiving diameter. Advantageously, the axial end face and/or receiving portion is directed toward the first bearing plate in the axial direction and/or faces away from the piston.

Advantageously, the second bearing plate is received in the receiving portion. Particularly preferably, the first bearing plate covers the receiving portion at least in portions, preferably for the most part or completely. In particular, the rolling elements are arranged between the first bearing plate and the second bearing plate and are thus arranged in regions and/or for the most part in the receiving portion.

In one embodiment of the disclosure, the receiving diameter of the receiving portion is larger than the inner diameter of the second bearing plate by a differential dimension. This allows radial displacement of the second bearing plate by the differential dimension in the receiving portion. The fact that the second bearing plate can move radially in the receiving portion can advantageously ensure the possibility of radial self-centering of the release bearing, in particular with respect to the shaft and/or the axially movable piston.

In an advantageous embodiment of the disclosure, the self-centering device comprises a spring device, which is designed to generate a spring force as the self-centering force. For example, the spring device is designed as an annular disc spring.

Advantageously, the disc spring is located in the receiving portion of the securing housing. In particular, the disc spring has an outer diameter which is smaller than the outer diameter of the first bearing plate and/or the second bearing plate. Preferably, the disc spring is arranged so that it is surrounded by the rolling elements in the radial direction. It is particularly preferred that the disc spring is supported on the second bearing plate. This allows the self-centering force to be transmitted to the second bearing plate. By means of the self-centering force acting on the second bearing plate, radial self-centering of the second bearing plate and thus of the release bearing is advantageously made possible. Preferably, the self-centering force is equal to or greater than displacement forces acting on the release bearing, in particular during operation of the clutch cylinder and/or multi-plate clutch. The displacement forces result, for example, from a frictional force generated by the transmission device and from friction coefficients acting between the transmission device and the first bearing plate or the second bearing plate and an adjacent component.

A further object of the disclosure is a clutch cylinder arrangement for a double-plate clutch of a motor vehicle with a first clutch cylinder and with a second clutch cylinder. The first clutch cylinder comprises a first release bearing arrangement according to the previous description and/or according to any of the preceding claims. The second clutch cylinder comprises a second release bearing arrangement according to the previous description and/or according to any of the preceding claims. Preferably, the first release bearing arrangement comprises a first release bearing and a first self-centering device with a first securing housing and with a first spring device. In particular, the second release bearing arrangement comprises a second release bearing and a second self-centering device with a second securing housing and with a second spring device.

In one embodiment of the disclosure, the first clutch cylinder comprises a first axially movable piston and the second clutch cylinder comprises a second axially movable piston. Preferably, the first piston is arranged concentrically and/or coaxially with the second piston. In particular, the second piston is radially surrounded by the first piston.

Advantageously, the first release bearing arrangement is associated with the first piston and the second release bearing arrangement is associated with the second piston. In particular, the first securing housing is attached to the first piston and the second securing housing is attached to the second piston. It is advantageous that the first release bearing arrangement is arranged concentrically and/or coaxially with the second release bearing arrangement. In particular, the second release bearing arrangement is radially surrounded by the first release bearing arrangement.

Due to the close spatial proximity of the two release bearing arrangements, radial displacement and mutual contact between the release bearings of the two release bearing arrangements can occur during operation of the clutch or clutch cylinder arrangement. For example, the second bearing plate of the first release bearing and the first bearing plate of the second release bearing can contact one another. In addition, during operation, it is possible for the first bearing plate of the first release bearing to contact the second bearing plate of the same release bearing. In both cases, this leads to damage and wear of the bearing plates and the intermediate rolling elements of at least one of the two release bearings, especially in the case of frequent contact. The fact that each of the two release bearing arrangements has a self-centering device means that the release bearings are kept centered in the radial direction. This prevents mutual contact between the two release bearings, so that damage and wear can no longer occur as a result. In particular, the possibility of self-centering can extend the service life of the first and second release bearings.

A further object of the disclosure is a double-plate clutch for a motor vehicle with the clutch cylinder arrangement according to the previous description and/or according to any one of claims 7 to 9.

The double-plate clutch can be a dry clutch or a wet clutch. Preferably, the double-plate clutch comprises two clutch units, wherein each clutch unit comprises a plate pack and a transmission device. Each clutch unit can switch connections to one shaft each, in particular to the hollow shaft and the inner concentric solid shaft of the motor vehicle. In particular, one clutch unit is switchable by a first clutch cylinder of the clutch cylinder arrangement and the other clutch unit is switchable by the second clutch cylinder of the clutch cylinder arrangement, so that odd gears of the motor vehicle can be operated by the one clutch unit and even gears can be operated by the other clutch unit. This means that the next gear can be preselected while torque is being transmitted to the shaft by one of the clutch units, and the change to the next gear can be made without interruption of tractive effort.

### BRIEF DESCRIPTION OF THE DRAWINGS

Further features, advantages and effects of the disclosure will be apparent from the following description of exemplary embodiments of the disclosure. In the figures:

FIG. 1 shows a double-plate clutch with a first release bearing and a second release bearing, each without a centering device;

FIG. 2 shows an exploded view of a release bearing arrangement with a release bearing, which comprises a cage with rolling elements and a first and second bearing plate, and with a self-centering device, which comprises a securing housing and a spring device;

FIG. 3 shows a perspective side view of the release bearing arrangement of FIG. 2 in the assembled state;

FIG. 4 shows a cross-section of the release bearing arrangement shown in FIG. 3;

FIG. 5 shows a detail of the cross-section of the release bearing arrangement of FIG. 4, showing the exact positioning of the spring device;

FIG. 6 shows the detail of FIG. 5 with a representation of centering forces acting on the release bearing.

### DETAILED DESCRIPTION

Corresponding or identical parts are designated with the same reference symbols in the figures.

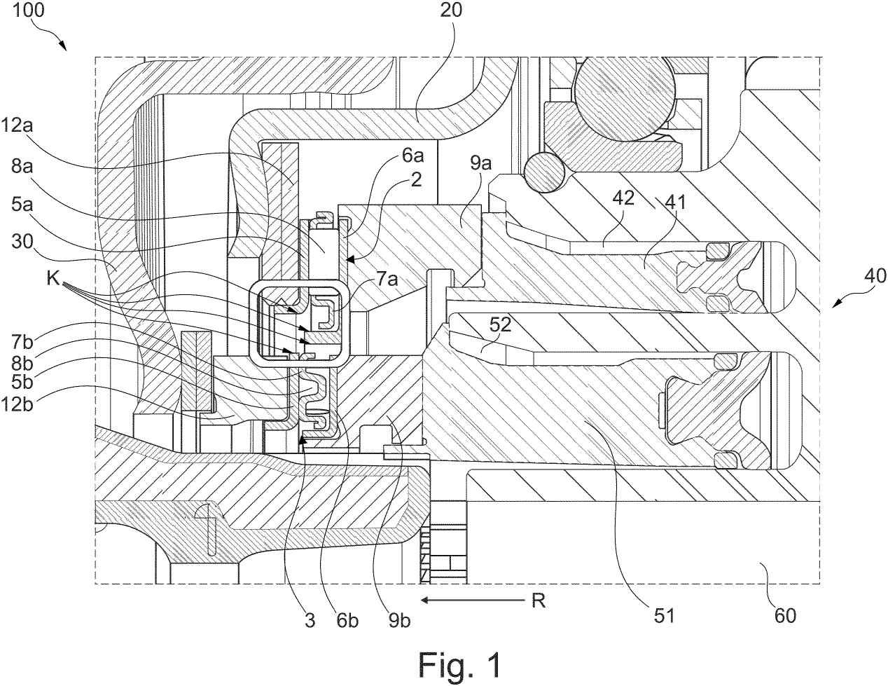

FIG. 1 shows a double-plate clutch 100 for a motor vehicle, for example with a hybrid drive. The double-plate clutch 100 transmits torque to a shaft 60 of the vehicle, wherein the shaft 60 comprises a hollow shaft and an inner solid shaft extending concentrically with the hollow shaft. The double-plate clutch 100 is designed as a wet clutch running in oil.

The double-plate clutch 100 comprises a first plate pack and a second plate pack (not shown), each having multiple plates. The double-plate clutch 100 comprises a first transmission device 20, a second transmission device 30 and a clutch cylinder arrangement 40. The clutch cylinder arrangement 40 has a first piston 41 and a first clutch cylinder 42, wherein the first piston 41 is movable in the first clutch cylinder 42 in an axial direction R relative to the shaft 60. The clutch cylinder arrangement 40 has a second piston 51 and a second clutch cylinder 52, wherein the second piston 51 is movable in the axial direction R in the second clutch cylinder 52. The first piston 41 and the second piston 42 are designed as annular pistons and the first and second clutch cylinders 42, 52 are designed to be annular in shape.

The clutch cylinder arrangement 40, the first and second clutch cylinders 42, 52 and/or the first and second pistons 41, 51 are seated on the shaft 60 and are arranged coaxially and/or concentrically to one another. The second clutch cylinder 52 is surrounded by the first clutch cylinder 42.

The first plate pack, the first clutch cylinder 42 and the first piston 41 are associated, for example, with the hollow shaft of the shaft 60 for transmitting a drive torque, wherein the second plate pack, the second clutch cylinder 52 and the second piston 51 are associated, for example, with the solid shaft of the shaft 60 for transmitting another drive torque.

The first transmission device 20 transmits an actuating force introduced by the first piston 41 to the first plate pack to form a frictional connection between the respective plates. The second transmission device 30 transmits an actuating force introduced by the second piston 7 to the second plate pack to form a frictional connection between the corresponding plates. When the frictional connection between the plates of one of the plate packs is formed, the double-plate clutch 100 can be actuated, a connection to the hollow shaft or to the solid shaft can be switched, and thus the next gear of the motor vehicle can be shifted without interrupting a transmission of torque through the other plate pack of the double-plate clutch 1.

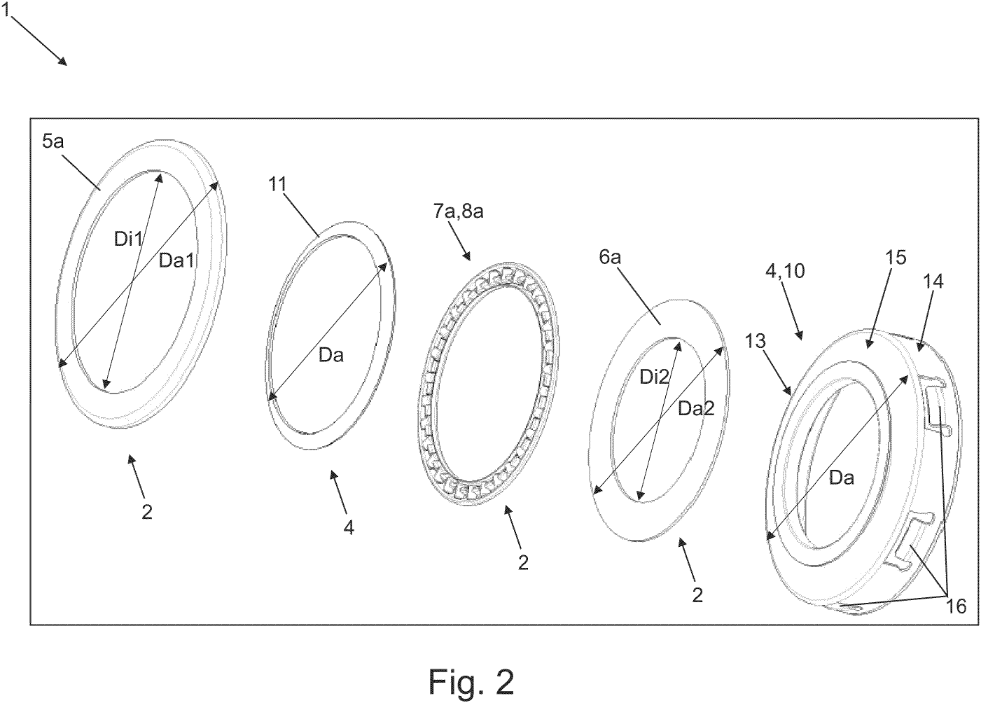

The double-plate clutch 100, in particular the clutch cylinder arrangement 40, has a first release bearing 2 and a second release bearing 3, wherein neither the first release bearing 2 nor the second release bearing 3 is assigned a centering device 4 (FIGS. 2-6) for radial self-centering with respect to the shaft 60 and/or to the respective piston 41, 51. Thus, FIG. 1 can show, in particular, a double-plate clutch 100 that is attributable to the prior art. A double-plate clutch 100 according to the disclosure provides a self-centering device 4 for each release bearing 2, 3, which is achieved by integrating two release bearing arrangements 1 (FIGS. 2-4) into the double-plate clutch 100, in particular into the clutch cylinder arrangement 40.

As shown in FIG. 1, the first release bearing 2 and the second release bearing 3 are designed as axial needle bearings. The first release bearing 2 comprises a first bearing plate 5a, a second bearing plate 6a, a cage 7a, and a plurality of rolling elements 8a held in the cage 7a and arranged so as to roll between the bearing plates 5a, 6a. The second release bearing 3 comprises a first bearing plate 5b, a second bearing plate 6b, a cage 7b, and a plurality of rolling elements 8b held in the cage 7b and arranged so as to roll between the bearing plates 5b, 6b.

The first release bearing 2 is connected to the first piston 41 at the second bearing plate 6a via a first connecting ring 9a of the double-plate clutch 100. The second release bearing 3 is connected to the second piston 51 at the second bearing plate 6b via a second connecting ring 9b of the double-plate clutch 100.

The first release bearing 2 transmits an actuating force introduced by the first piston 41 in the axial direction R to the first transmission device 20 with the interposition of at least one further component 12a between the first bearing plate 5a and the first transmission device 20. The second release bearing 3 transmits an actuating force introduced by the second piston 51 in the axial direction R to the second transmission device 30 with the interposition of at least one further component 12b between the first bearing plate 5b and the second transmission device 30. The actuating force is transmitted, in particular, to form the frictional connection between the plates of the respective plate pack.

The first release bearing 2 is arranged coaxially and/or concentrically with respect to the shaft 60 and in spatial proximity to the second release bearing 3. The first release bearing 2 surrounds the second release bearing 3. In the radial direction outward with respect to the shaft 60, the first release bearing 2 is secured in the first connecting ring 9a in a form-fitting manner. The second release bearing 3 is secured in the radial direction inward with respect to the shaft 60 by the second connecting ring 9b in a form-fitting manner. Thus, during operation of the double-plate clutch 100, play in the radial direction is possible between the two release bearings 2, 3, allowing movement of the two release bearings 2, 3 towards one another. For this reason, and in particular due to the lack of self-centering devices 4, the two release bearings 2, 3 can come into mutual contact. The second bearing plate 6b of the second release bearing 3 can contact the first bearing plate 5a of the first release bearing 2. Furthermore, contact can occur between the first bearing plate 5a and the second bearing plate 6a of the first release bearing 2. In FIG. 1, possible contact points K of the two release bearings 2, 3 and their bearing plates 5a, 6a, 5b are highlighted.

To avoid mutual contact of the release bearings 2, 3 and/or contact of the bearing plates 5a, 6a of the first release bearing 2, a self-centering device 4 is associated with each release bearing 2, 3 according to the disclosure, so that a release bearing arrangement 1 is formed, which comprises a release bearing 2, 3 and the self-centering device 4. In particular, in accordance with the present disclosure, two release bearing arrangements 1 are therefore to be provided in the double-plate clutch 100 to ensure radial self-centering of each release bearing 2, 3.

The release bearing arrangement 1 is shown in an exploded view in FIG. 2. It comprises, in an exemplary manner, the first release bearing 2 with the first and second bearing plates 5a, 6a, the cage 7a with the rolling elements 8a held therein, and the self-centering device 4. The self-centering device 4 comprises a securing housing 10 and a spring device designed as a disc spring 11 for generating a self-centering force K. Alternatively, the release bearing arrangement 1 can also comprise the second release bearing 3, its components and the self-centering device 4.

The first and second bearing plates 5a, 6a are designed to be annular in shape. The first bearing plate 5a has an outer diameter Da1 and the second bearing plate 6a has an outer diameter Da2. The first bearing plate 5a has an inner diameter Di1 and the second bearing plate 6a has an inner diameter Di2. The disc spring 11 is designed as a ring having an outer diameter Da, which is larger than the inner diameter Di1 of the first bearing plate 5a and smaller than the outer diameter Da2 of the second bearing plate 6a.

The securing housing 10 is designed as a circular cylinder and is annular in an axial plan view. It has an axial end face 13 and a housing jacket 14. The end face 13 has a receiving portion 15 with a receiving diameter Da, wherein the first release bearing 2 can be received at least in regions in the receiving portion 15. Form-fit interfaces 16 are arranged on the housing jacket 14 at regular distances from one another in the direction of rotation for a form-fitting attachment of the securing housing 10 to the first piston 41 (FIG. 1), for example. The securing housing 10 can be attached onto or inserted into the first piston 41 and connected to it in a form-fitting manner.

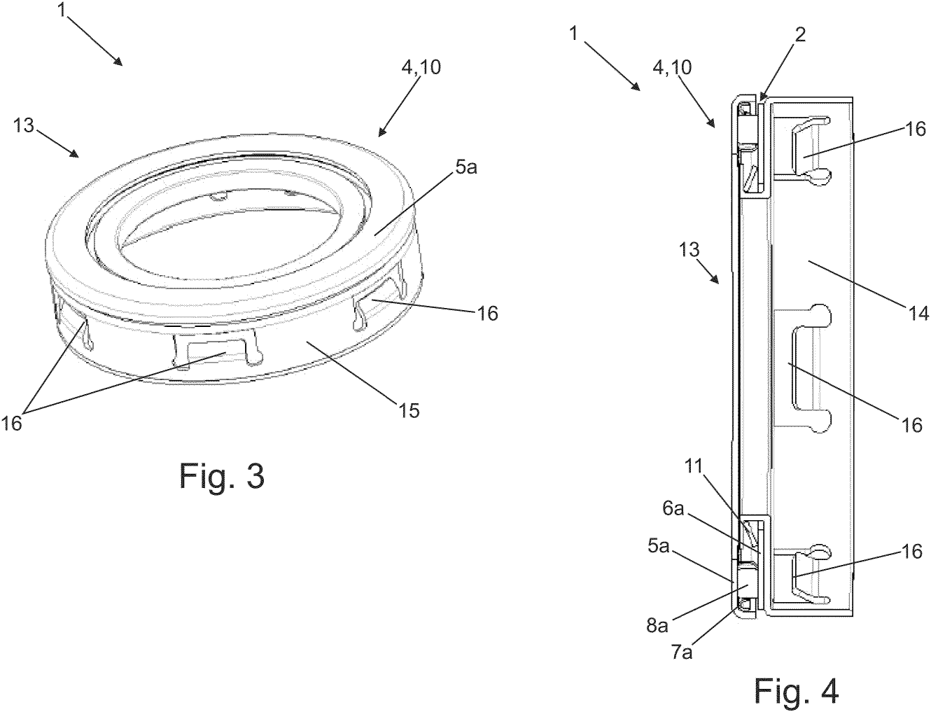

FIG. 3 shows a perspective side view of the release bearing arrangement 1 and FIG. 4 shows a cross-section, each in the assembled state. The first release bearing 2 is received in regions in the receiving portion 15. The second bearing plate 6a is completely received and the first bearing plate 5a partially covers the receiving portion 15, in particular for the most part. Between the first bearing plate 5a and the second bearing plate 6a, the rolling elements 8a held in the cage 7a are arranged so as to roll. The disc spring 11 is accommodated in the receiving portion 15. There it is surrounded by the rolling elements 8a.

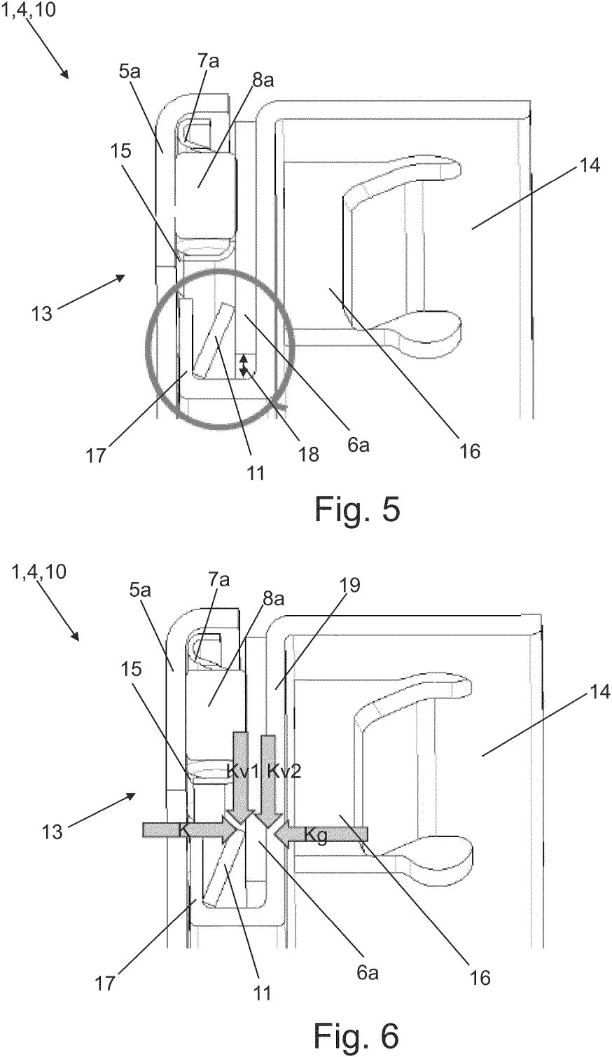

As can be seen from the detailed view of FIG. 5, the disc spring 11 is supported against a boundary wall 17 of the receiving portion 15 and against the second bearing plate 6a to transmit the self-centering force K to the second bearing plate 6a and thus to the first release bearing 2.

It can also be seen that the outer diameter Da2 of the second bearing plate 6a (FIG. 2) is smaller than the receiving diameter Da of the receiving portion 15 by a distance dimension 18. Due to the distance dimension 18, a radial displacement of the second bearing plate 6a and thus of the first release bearing 2 with respect to the shaft 60 and/or to the first annular pin 41 (FIG. 1) is possible during operation of the double-plate clutch 100 and/or the clutch cylinder arrangement 40.

The effect of forces acting on the second bearing plate 6a and thus on the first release bearing 2 during operation of the double-plate clutch 100 and/or the clutch cylinder arrangement 40 is shown in the detailed view of FIG. 6.

The disc spring 11 exerts the axially directed self-centering force K, which corresponds to the counterforce Kg with which the second bearing plate 6a is pressed against a support wall 19 of the receiving portion 15 directed toward the housing jacket 14. The second bearing plate 6a is also subjected to radially directed displacement forces Kv1, Kv2, each resulting from a frictional force Fr of the transmission device 20, a first coefficient of friction µ1 between the transmission device 20 and the first bearing plate 5a, and a second coefficient of friction µ2 between the first bearing plate 5a and the second bearing plate 6a or between the second bearing plate 6a and the support wall 19. The following equations thus apply: Kv1 = Fr x µ1 and Kv2 = Fr x µ2. Consequently, the total displacement force acting is thus Kv1 + Kv2 = Fr x (µ1 + µ2).

To prevent or correct radial displacement of the first release bearing 2, the self-centering force K introduced into the second bearing plate 6a by the disc spring 11 must be equal to or greater than the total displacement force Kv1+Kv2.

With reference to the double-clutch device 100 of FIG. 1, by integrating a self-centering device 4 associated with the first release bearing 2 and a self-centering device 4 associated with the second release bearing 3 (as shown in FIGS. 3, 4 as a release bearing arrangement 1), the radial displacement of the two release bearings 2, 3, in particular towards one another, and thus mutual contact and resulting damage can be prevented. Furthermore, the integration of the self-centering device 4 can prevent the first bearing plate 5a and the second bearing plate 6a of the first release bearing 2 from contacting and damaging one another due to the displacement. Thus, the service life of the double-plate clutch 100 and/or the clutch cylinder arrangement 40 can be extended.

### List of Reference Symbols

1 Release bearing arrangement

2 First release bearing

3 Second release bearing

4 Self-centering device

5a First bearing plate of the first release bearing

5b First bearing plate of second release bearing

6a Second bearing plate of first release bearing

6b Second bearing plate of second release bearing

7a Cage of the first release bearing

7b Cage of the second release bearing

8a Rolling element of the first release bearing

8b Rolling element of the second release bearing

9a First connecting ring

9b Second connecting ring

10 Securing housing

11 Disc spring

12a First further component

12b Second further component

13 End face

14 Housing jacket

15 Receiving portion

16 Form-fit interfaces

17 Boundary wall

18 Differential dimension

19 Support wall

20 First transmission device

30 Second transmission device

40 Clutch cylinder arrangement

41 First piston

42 First clutch cylinder

51 Second piston

52 Second clutch cylinder

60 Shaft

100 Double-plate clutch

1. A release bearing arrangement for a pistonof a clutch cylinder of a multi-plate clutch, the piston being axially movable along a shaft of a motor vehicle, the release bearing arrangement comprising:
a release bearing configured for axial force transmission of an actuating force introduced by the piston to a transmission device of the multi-plate clutch,
wherein the release bearing comprises a first bearing plate, a second bearing plate and a plurality of rolling elements, wherein the rolling elements are arranged so as to roll between the first bearing plate and the second bearing plate, and
a self-centering deviceconfigured for radial self-centering of the release bearing relative to the shaft and relative to the piston that is axially movable along the shaft.

2. The release bearing arrangement according to claim 1, wherein the self-centering device comprises a securing housing configured for accommodating the release bearing in regions and for securing the release bearing to the piston.

3. The release bearing arrangement according to claim 2, wherein the securing housing is designed as a circular cylinder, wherein the securing housing has an annular receiving portion on an axial end face, wherein the second bearing plate is received in the receiving portion and wherein the first bearing plate at least partially covers the receiving portion.

4. The release bearing arrangement according to claim 3, wherein the second bearing plate has an inner diameter and in that the receiving partion has a receiving diameter, wherein the receiving diameter is larger than the inner diameter by a differential dimension.

5. The release bearing arrangement according to wherein the self-centering device comprises a spring device configuredfor generating a self-centering force.

6. The release bearing arrangement according to claim 5, wherein the spring device is an annular disc spring, wherein the disc spring is arranged in the receiving portion of the securing housing and is supported on the second bearing plate for transmitting the self-centering force.

7. A clutch cylinder arrangement for a double-plate clutch of a motor vehicle, comprising a first clutch cylinderand a second clutch cylinder, wherein the first clutch cylinder comprises a first release bearing arrangement and the second clutch cylinder comprises a second release bearing arrangement, the first release bearing arrangement and the second release bearing arrangement each comprising:
a release bearing configured for axial force transmission of an actuating force introduced by a piston to a transmission device, the piston being axially movable along a shaft of the motor vehicle,
wherein the release bearing comprises a first bearing plate, a second bearing plate and a plurality of rolling elements, wherein the rolling elements are arranged so as to roll between the first bearing plate and the second bearing plate, and
a self-centering device configured for radial self-centering of the release bearing relative to the shaft and relative to the piston that is axially movable along the shaft.

8. The clutch cylinder arrangement according to claim 7, wherein the first release bearing arrangement is arranged concentrically and coaxially with the second release bearing arrangement, wherein the second release bearing arrangement is surrounded by the first release bearing arrangement, wherein the self-centering devices of the first release bearing arrangement and the second release bearing arrangement prevent mutual contact between the release bearings during operation of the clutch cylinder arrangement.

9. The clutch cylinder arrangement according to claim 7, wherein the self-centering device of the first release bearing arrangement prevents contact between the first bearing plate and the second bearing plate of the first release bearing.

10. A double-plate clutch for a motor vehicle having the clutch cylinder arrangement according to claim 7.
